(19) United States
(12) Patent Application Publication
(10) Pub. No.: US 2022/0050528 A1
(43) Pub. Date: Feb. 17, 2022

(54) ELECTRONIC DEVICE FOR SIMULATING A MOUSE

(71) Applicant: Acer Incorporated, New Taipei City (TW)

(72) Inventors: Cheng-Tse WU, New Taipei City (TW); An-Cheng LEE, New Taipei City (TW); Wei-Ren LIN, New Taipei City (TW); Ying-Shih HUNG, New Taipei City (TW)

(21) Appl. No.: 17/356,740

(22) Filed: Jun. 24, 2021

(30) Foreign Application Priority Data
Aug. 14, 2020 (TW) 109127668

(51) Int. Cl. G06F 3/01; G06F 3/0481; G06K 9/00; H04N 5/232; G06N 3/08; G06F 16/51

(52) U.S. Cl. CPC G06F 3/017; G06F 3/04815; G06K 9/00355; G06F 16/51; H04N 5/23219; H04N 5/23299; G06N 3/08; G06K 9/00375

(57) ABSTRACT

An electronic device includes a camera, a display, and a processor. The camera provides an image. The display displays a cursor. The processor executes a palm detection algorithm to identify a palm in the image and mark a bounding box around the palm. The processor also executes a hand key-point detection algorithm to mark a plurality of key points on the palm that has been marked in the image to obtain spatial coordinates of key points on the palm. The processor executes a hand motion detection algorithm to control the camera to turn in the corresponding direction, move the cursor in the display in a way that corresponds to the position change of the bounding box around the palm, and trigger an event according to the change of the spatial coordinates of at least one of the key points on the palm within a certain period of time.

### CROSS REFERENCE TO RELATED APPLICATIONS

This application claims priority to and the benefit of Taiwan Application No. 109127668, filed on Aug. 14, 2020, the entirety of which is incorporated by reference herein.

### FIELD OF THE INVENTION

The invention relates to an electronic device, especially one relating to the electronic device used to simulate a mouse, which is called a virtual mouse.

### DESCRIPTION OF THE RELATED ART

In the existing virtual mouse technology used to replace the physical mouse, the manufacturers replace the physical mouse or the traditional mouse in the following ways, including presenting a virtual touchpad on the display, using a sensor to detect the distance between the finger and the touch panel to enlarge the position of the touch area, developing a pair of gloves for man-machine interface, using a tactile feedback mouse with a touch screen, developing a mouse with touch function, or developing a keyboard system combined with touch gestures. However, no manufacturer has proposed to design a virtual mouse design by using a camera to detect a user's finger and applying artificial intelligence.

### BRIEF SUMMARY OF THE INVENTION

In order to resolve the issues described above, an embodiment of the invention provides an electronic device. The electronic device includes a camera, a display, and a processor. The camera provides an image. The display displays a cursor. The processor executes a palm detection algorithm to identify a palm in the image and to mark a bounding box around the palm. The processor also executes a hand key-point detection algorithm to mark a plurality of key points on the palm (which has been marked in the image) to obtain the spatial coordinates of the key points on the palm. The processor also executes a hand motion detection algorithm to control the camera so that it turns in the corresponding direction, to correspondingly move the cursor in the display so that it corresponds to the position change of the bounding box around the palm. The processor also triggers an event according to the change of the spatial coordinates of at least one of the key points on the palm within a certain period of time.

The electronic device disclosed above also includes a database. The database stores a plurality of images of the palm. The processor inputs the images related to the palm into the palm detection algorithm and the hand key-point detection algorithm for deep learning.

According to the electronic device disclosed above, the processor executes the hand motion detection algorithm, so that the processor calculates the center point coordinates, which correspond to the center point of the bounding box according to the range of the bounding box.

According to the electronic device disclosed above, the palm detection algorithm and the hand key-point detection algorithm are convolution neural network (CNN) algorithms. The hand key-point detection algorithm is also a convolution pose machine (CPM) algorithm.

According to the electronic device disclosed above, the processor executes the hand motion detection algorithm, which includes the following steps: obtaining the first center point coordinates of the bounding box at a first time point; obtaining a second center point coordinates of the bounding box at a second time point; calculating the displacement value of the palm according to the first center point coordinates and the second center point coordinates; converting the displacement value into a pixel coordinate displacement value in the display; and moving the cursor in the display according to the pixel coordinate displacement value.

According to the electronic device disclosed above, the processor executes the hand motion detection algorithm, which includes the following steps: obtaining the first center point coordinates of the bounding box at a first time point; obtaining the second center point coordinates of the bounding box at a second time point; calculating the displacement value of the palm according to the first center point coordinates and the second center point coordinates; and outputting a corresponding control signal to the camera according to the displacement value, so that the camera turns in a direction, according to the control signal.

According to the electronic device disclosed above, the processor executes the hand motion detection algorithm, which includes the following steps: obtaining the first spatial coordinates of at least one of the key points at a first time point; obtaining the second spatial coordinates of at least one of the key points at a second time point; calculating the vertical displacement value of at least one of the key points on the palm according to the first spatial coordinates and the second spatial coordinates; and calculating the displacement speed of at least one of the key points on the palm according to the time difference between the first time point and the second time point and the vertical displacement value.

According to the electronic device disclosed above, at least one of the key points on the palm is the key point at the extreme end of an index finger or a middle finger on the palm.

According to the electronic device disclosed above, the processor triggers the event comprising: executing an action performed when the left button or the right button of a mouse is clicked.

According to the electronic device disclosed above, the camera is a pan-tilt-zoom (PTZ) camera.

### BRIEF DESCRIPTION OF THE DRAWINGS

The invention can be more fully understood by reading the subsequent detailed description with references made to the accompanying figures. It should be understood that the figures are not drawn to scale in accordance with standard practice in the industry. In fact, the size of components may be arbitrarily enlarged or reduced in the figures for clarity of illustration.

FIG. 1 is a schematic diagram of an electronic device in accordance with some embodiments of the disclosure.

FIG. 2 is a schematic diagram of hand key points in accordance with some embodiments of the disclosure.

FIG. 3 is a schematic diagram of a processor of the electronic device detecting a fingertip click in accordance with some embodiments of the disclosure.

FIG. 4 is a flow chart of the processor of the electronic device detecting the fingertip click in accordance with some embodiments of the disclosure.

FIG. 5 is a schematic diagram of the processor of the electronic device detecting hand motion in accordance with some embodiments of the disclosure.

FIG. 6 is a flow chart of the processor of the electronic device detecting hand motion in accordance with some embodiments of the disclosure.

FIG. 7 is a flow chart of the processor of the electronic device controlling a camera to track the hand in accordance with some embodiments of the disclosure.

### DETAILED DESCRIPTION OF THE INVENTION

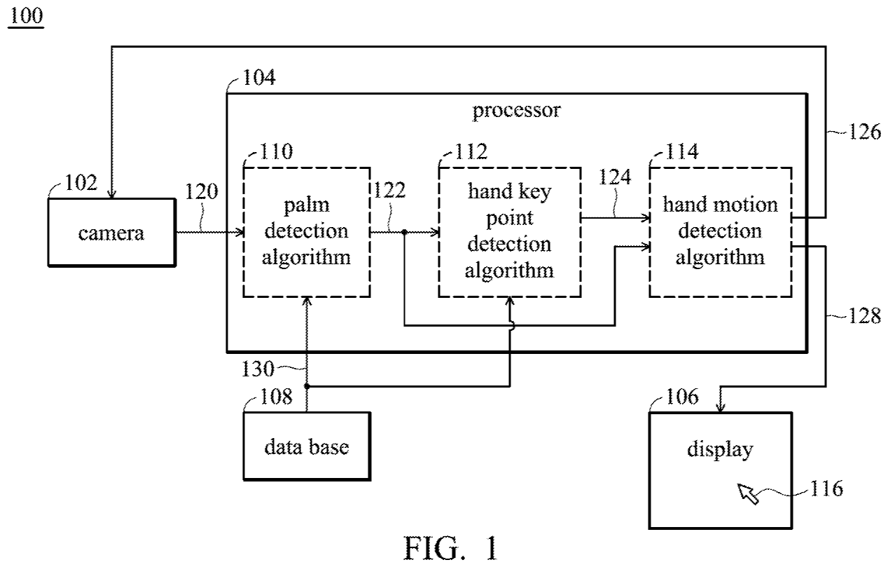

FIG. 1 is a schematic diagram of an electronic device 100 in accordance with some embodiments of the disclosure. As shown in FIG. 1, the electronic device 100 includes a camera 102, a processor 104, a display 106, and a database 108. The camera 102 provides an image 120 to the processor 104. In some embodiments, the camera 102 is a pan-tilt-zoom (PTZ) camera, whose lens has different functions of panning, tilting, and zooming. In other words, the camera 102 cab change the angle of photography, the range of photography, and the sharpness of photography at any time according to a control signal 126. Compared with a traditional camera that can only perform a single motion, the camera 102 can obtain a better monitoring effect. In some embodiments, the camera 102 is set at a position where its lens is sufficient to capture the user's hand. In some embodiments, the electronic device 100 is a desktop computer, a laptop, a server, or a smart mobile device. In some embodiments, the processor 104 is a central processing unit (CPU), a system-on-chip (SoC), a microcontroller unit (MCU), or a field programmable gate array (FPGA).

The processor 104 executes a palm detection algorithm 110, and inputs the received image 120 into the palm detection algorithm 110, so that the processor 104 identifies a palm in the image 120, and marks a bounding box around the palm. The bounding box is used to indicate the range of the palm in the image 120. In some embodiments, when a bounding box appears around the palm in the image 120, it means that the processor 104 has identified an object of the “palm” in the image 120 through the palm detection algorithm 110. In some embodiments, the processor 104 displays the image 120 and the palm marked by the bounding box in the display 106 to indicate the user that the processor 104 has recognized the palm in the image 120. In some embodiments, the processor 104 does not display the image 120 and the palm marked by the bounding box in the display 106, but only makes the image 120 and the palm marked by the bounding box as marking data 122 in FIG. 1 for subsequent algorithm processing.

In some embodiments, before the processor 104 executes the palm detection algorithm 110 to identify the palm in the image 120, the processor 104 needs to reads a plurality of images related to the “palm” in the database 108 through an access interface 130. The processor 104 inputs the images related to the “palm” into the palm detection algorithm 110 for deep learning. In other words, the palm detection algorithm 110 must learn or be trained in advance how to identify a palm in the image 120. In some embodiments, the palm detection algorithm 110 is a convolutional neural network (CNN) algorithm. The palm detection algorithm 110 includes convolution layers and pooling layers. When the image 120 is input to the palm detection algorithm 110 by the processor 104, the convolution layers of the palm detection algorithm 110 are used to capture the feature of the “palm” in the image 120. In some embodiments, the database 108 is a nonvolatile memory.

In some embodiments, the convolution layers of the palm detection algorithm 110 have a plurality of feature filters (or kernel maps) to capture the features of the “palm” in the image 120. The pooling layers of the palm detection algorithm 110 combine the features of the “palm” in the image 120 captured by the convolution layers to reduce the amount of image data and retain the most important information of the features of the “palm”. In other words, the training process of the palm detection algorithm 110 is that the processor 104 uses the images in the database 108 to set the parameters of the feature filters in the convolution layers of the palm detection algorithm 110 to enhance the ability of the palm detection algorithm 110 for capturing the features of the “palm”.

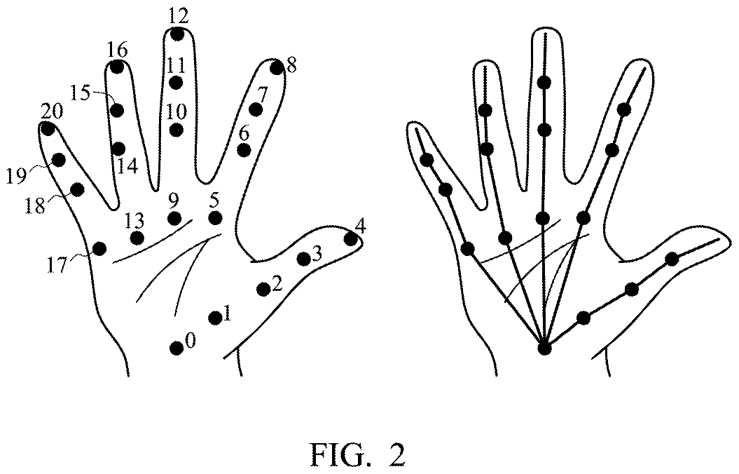

Then, the processor 104 executes the hand key-point detection algorithm 112, and inputs the marking data 122 to the hand key-point detection algorithm 112, so that the processor 104 can mark a plurality of key points of the palm marked by the bounding box in the marking data 122, and can calculate spatial coordinates of the key points. FIG. 2 is a schematic diagram of hand key points in accordance with some embodiments of the disclosure. As shown in FIG. 2, the processor 104 executes the hand key-point detection algorithm 112, so that the processor 104 marks a plurality of key points at knuckles, fingertips and a background of the palm in the marking data 122 respectively. For example, the processor 104 marks total 21 key points such as key points 0-20, and marks the background of the palm as a key-point 22.

The processor 104 executes the hand key-point detection algorithm 112, so that the processor 104 further can obtain spatial coordinates of the key points 0-20 in the image 120. Generally, any points in the image 120 only have 2D coordinates. However, the processor 104 executes the hand key-point detection algorithm 112, so that the processor 104 obtains 3D coordinates corresponding to the key points 0˜20 according to the turning angle of the palm in the image 120 and the size of the palm in the image 120. After that, the processor 104 outputs key-point data 124 (including the 3D coordinates of the key points 0˜20) to the hand motion detection algorithm 114 for subsequent calculation.

In some embodiments, before the processor 104 executes the hand key-point detection algorithm 112 to identify the key points of the palm in the image 120, the processor 104 has to read a plurality of images related to “palm key-point” in the database 108 through the access interface 130 first, and inputs the images related to the “palm key-point” into the hand key-point detection algorithm 112 for deep learning. In other words, the hand key-point detection algorithm 112 has to learn or be trained in advance how to identify the key points of the palm in an image 120. In some embodiments, the hand key-point detection algorithm 112 is a convolution pose machine (CPM) algorithm in a convolution neural network (CNN) algorithm. The hand key-point detection algorithm 112 has a plurality of stages, each of which includes a plurality of convolution layers and a plurality of pooling layers.

Similarly, the convolution layers of the hand key-point detection algorithm 112 are also used to capture the key-point features (such as knuckle features, fingertip features and a background feature) on the palm marked by the bounding box in the marking data 122. The pooling layers of the palm detection algorithm 112 combine the key-point features of the “palm” marked by the bounding box in the marking data 122 captured by the convolution layers to reduce the amount of image data and retain the most important information of the features of the “palm key-point”. After the processor 104 completes the calculation of one of the stages in the hand key-point detection algorithm 112, the processor 104 outputs a supervisory signal to the next one of the stages. The supervisory signal includes feature maps obtained in the previous stage and loss obtained in the previous stage. The feature maps and the loss can be provided to subsequent stages as input. The subsequent stages can analyze and calculate based on the feature maps and the loss of the previous stages to obtain the position (including 3D coordinates) of the most confident “palm key-point” features on the palm.

For example, when the processor 104 inputs the marking data 122 into the hand key-point detection algorithm 112, the detection results of the “palm key-point” can be obtained preliminary and roughly after calculation. Then, when the processor 104 executes the hand key-point detection algorithm 112, the processor 104 performs key-point triangulation on the marking data 122 to obtain the 3D position of the “hand key point”. After that, the processor 104 projects the 3D position of the “palm key-point” to the key-point data 124 (such as those in FIG. 2), and matches the 3D position of the “palm key-point” with the positions of the key points in the key-point data 124. The processer 104 trains and optimizes the key points (by the hand key-point detection algorithm 112) according to the images related to the “palm key-point” in the database 108, so as to obtain the correct 3D spatial coordinates of the “palm key-point”.

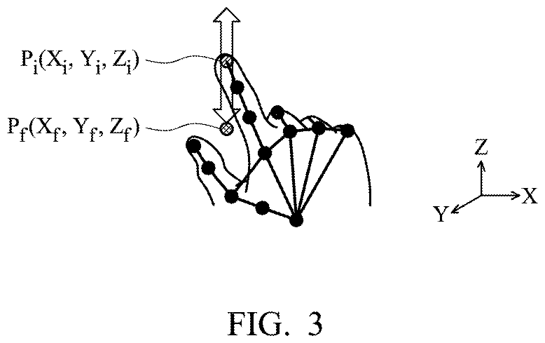

Then, the processor 104 executes the hand motion detection algorithm 114, and inputs the key-point data 124 into the hand motion detection algorithm 114, so that the processor 104 can trigger an event according to the change of the (3D) spatial coordinates of at least one of the key points on the palm in the key-point data 124 within a certain period of time. In some embodiments, the at least one of the key points in the key-point data 124 can be the key points at the extreme ends of an index finger and a middle finger on the palm (that is, the key points at the index fingertip or the middle fingertip). FIG. 3 is a schematic diagram of a processor 104 of the electronic device 100 detecting a fingertip click in accordance with some embodiments of the disclosure. As shown in FIG. 3, the processor 104 executes the hand motion detection algorithm 114, so that the processor 104 obtains the spatial coordinates of the key point of the index fingertip or the key point of the middle fingertip (that is, key point 8 and key point 12 in FIG. 2) at a first time point.

Take the key point of the index fingertip (key point 8) as an example, the processor 104 obtains spatial coordinates Pᵢ (Xᵢ, Yᵢ, Zᵢ) of the key point of the index fingertip at a first time point. Then, at a second time point, which is later than the first time point, the processor obtains spatial coordinates P_{f}(X_{f}, Y_{f}, Z_{f}) of the key point of the index fingertip. The processor calculates a vertical displacement value AZ (that is ΔZ=Z_{f}-Zᵢ) between the spatial coordinates Pᵢ (Xᵢ, Yᵢ, Zᵢ) of the key point of the index fingertip at the first time point and the spatial coordinates P_{f}(X_{f}, Y_{f}, Z_{f}) at the second time point. The processor 104 calculates a displacement speed V of the key point of the index fingertip according to a time difference Δt between the first time point and the second time point, that is, V=ΔZ/Δt=(Z_{f}-Zᵢ)/Δt. When the displacement speed V is higher than a first threshold, and the vertical displacement value ΔZ is larger than a second threshold, the processor 104 triggers the event. In some embodiments, when the processor 104 triggers the event, the processer 104 executes an action performed when a left button (corresponding to the key point of the index fingertip, that is, key point 8) or a right button (corresponding to the key point of the middle fingertip, that is, key point 12) of a mouse is clicked. For example, before the processor 104 triggers the event, the cursor 16 in the display 106 stays on a folder. The processor 104 then triggers the event to cause the display 106 shows up the opening folder.

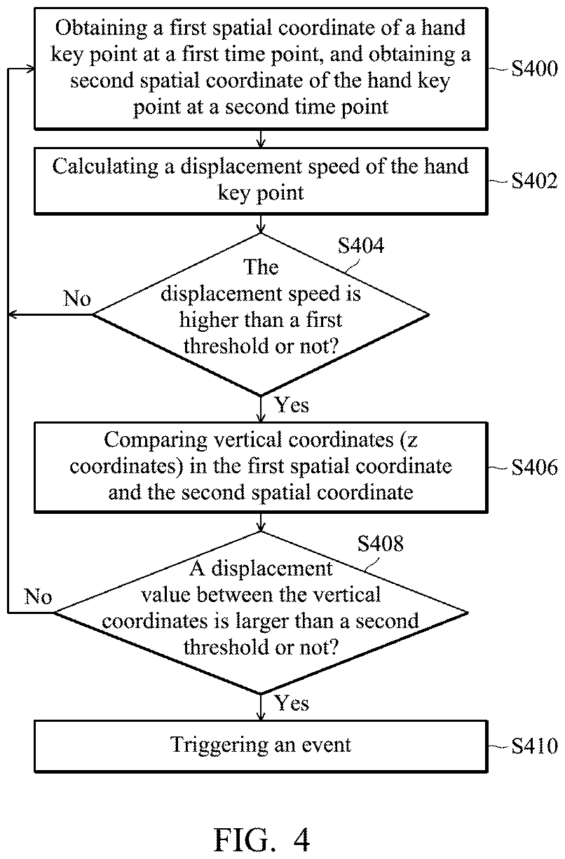

FIG. 4 is a flow chart of the processor 104 of the electronic device 100 detecting the fingertip click in accordance with some embodiments of the disclosure. As shown in FIG. 4, the processor 104 executes the hand motion detection algorithm 114 to detect a fingertip click including steps S400˜S410. In step S400, the processor 104 obtains first spatial coordinates (for example, the spatial coordinates Pᵢ (Xᵢ, Yᵢ, Zᵢ) of the hand key point at a first time point, and obtains a second spatial coordinates (for example, the spatial coordinates P_{f}(X_{f} Y_{f}, Z_{f}) of the hand key point at a second time point. In step S402, the processor 104 calculates a displacement speed of the hand key point according to a time difference between the first time point and the second time point and a displacement value between the first spatial coordinates and the second spatial coordinates.

After that, in step S404, the processor 104 determines the displacement speed is higher than a first threshold or not. When the displacement speed is higher than the first threshold, the processor 104 then compares the displacement value of the vertical coordinates (such as z coordinates) in the first spatial coordinates and the second spatial coordinates in step S406. In step S408, the processor 104 determines a displacement value between the vertical coordinates is larger than a second threshold or not. When the displacement value between the vertical coordinates is larger than the second threshold, the processor 104 trigger an event in step S410. In some embodiments, when the displacement speed calculated out in step S402 is lower or equal to the first threshold, the processor 104 executes step S400 again. In some embodiments, when the displacement value between the vertical coordinates is less than the second threshold, the processor 104 executes step S400 again and does not trigger the event. In other words, only when step S404 and step S408 are all positive, the processor 104 triggers the event.

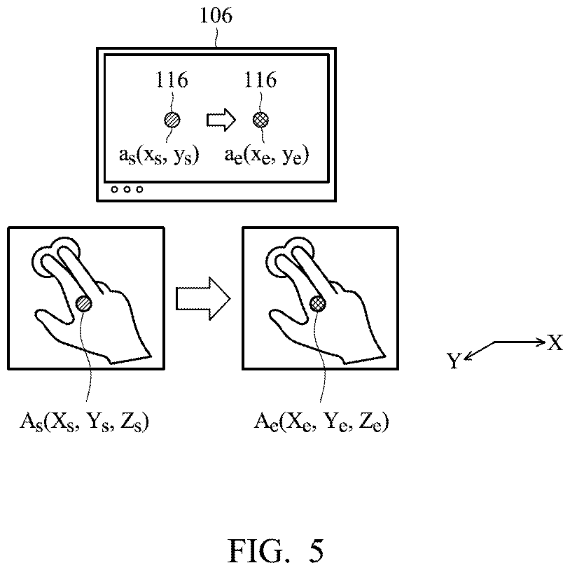

In some embodiments, the processor 104 executes the hand motion detection algorithm 114, so that the processor 104 calculates center point coordinates corresponding to a center point of the bounding box according to the range of the bounding box in the marking data 122. In some embodiments, since the marking data 122 records the coordinates of points on the bounding box, the processor 104 can calculate the center point coordinates according to the coordinates of the points on the bounding box. In some embodiments, the bounding box used to mark the palm in the marking data 122 is rectangle, but the present invention is not limited thereto. FIG. 5 is a schematic diagram of the processor 104 of the electronic device 100 detecting hand motion in accordance with some embodiments of the disclosure. As shown in FIG. 5, the processor 104 executes the hand motion detection algorithm 114, so that the processor 104 obtains center point coordinates Aₛ (Xₛ, Yₛ, Zₛ) of the bounding box used to mark the palm in the marking data 122 at the first time point. The center point coordinates Aₛ (Xₛ, Yₛ, Zₛ) of the bounding box used to mark the palm may correspond to a pixel coordinates aₛ (xₛ, yₛ, zₛ) in the display 106 where the cursor 116 is located at the same time. Then, after the user's hand moves on the X-Y plane (the plane where the user's hand is placed), which is orthogonal to the display 106, the processor 104 obtains center point coordinates Aₑ (Xₑ, Yₑ, Zₑ) of the bounding box used to mark the palm in the marking data 122 at the second time point. The first time point is earlier than the second time point. The center point coordinates Aₑ (Xₑ, Yₑ, Zₑ) of the bounding box used to mark the palm may correspond to a pixel coordinates aₑ (xₑ, yₑ, zₑ) in the display 106 where the cursor 116 is located at the same time.

After that, the processor 104 calculates a displacement value (ΔX, ΔY) of the palm according to the center point coordinates Aₛ (Xₛ, Yₛ, Zₛ) at the first time point and the center point coordinates Aₑ (Xₑ, Yₑ, Zₑ) at the second time point, wherein ΔX=Xₑ-Xₛ, ΔY=Yₑ-Yₛ. The processor 104 converts the displacement value into pixel coordinates displacement value (Δx, Δy) in the display 106. For example, the processor 104 sets a parameter value α according to the pixels of the display 106. The processor 104 calculates the pixel coordinates displacement value (Δx, Δy) moving from the pixel coordinates aₛ (xₛ, yₛ, zₛ) to the pixel coordinates aₑ (xₑ, yₑ, zₑ) in the display 106 through multiplication by parameter value α, wherein Δx=α*ΔX, Δy=α*ΔY. Therefore, the processor 104 moves the cursor 116 in the display 106 from the pixel coordinates aₛ (xₛ, yₛ, zₛ) to the pixel coordinates aₑ (xₑ, yₑ, zₑ) through a communication interface 128 according to the calculated pixel coordinates displacement value (Δx, Δy). In other words, the processor 104 executes the hand motion detection algorithm 114 to convert the 3D center point coordinates of the bounding box used to mark the palm in the marking data 122 into the 2D pixel coordinates in the display 106.

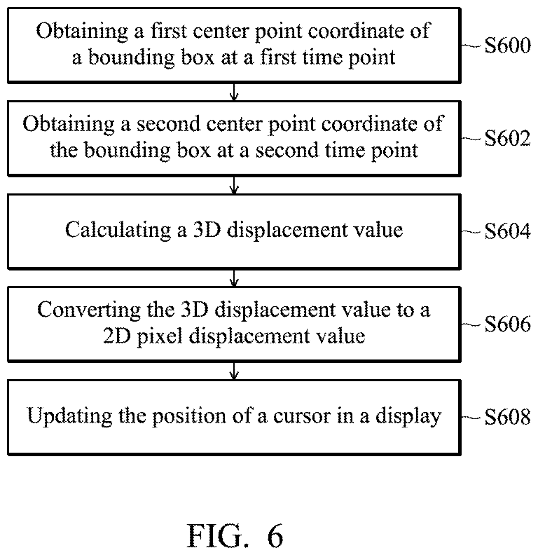

FIG. 6 is a flow chart of the processor 104 of the electronic device 100 detecting hand motion in accordance with some embodiments of the disclosure. As shown in FIG. 6, the process for the processor 104 executing the hand motion detection algorithm 114 to detect hand movement includes steps S600˜S608. In step S600, the processor 104 obtains a first center point coordinates of the bounding box used to mark the palm at a first time point. In step S602, the processor 104 obtains second center point coordinates of the bounding box used to mark the palm at a second time point. Then, in step S604, the processor 104 calculates a 3D displacement value of the bounding box used to mark the palm according to the first center point coordinates and the second center point coordinates. In step S606, the processor 104 converts the 3D displacement value into a 2D pixel displacement value. Finally, in step S608, the processor 104 updates (or moves) the position of the cursor 116 in the display 106 through the communication interface 128 according to the 2D pixel displacement value.

In some embodiments, the processor 104 executes the hand motion detection algorithm 114, so that the processor obtains the center point coordinates Aₛ (Xₛ, Yₛ, Zₛ) of the bounding box used to mark the palm in the marking data 122 at the first time point, and obtains the center point coordinates Aₑ (Xₑ, Yₑ, Zₑ) of the bounding box used to mark the palm in the marking data 122 at the second time point. The processor 104 calculates the displacement value (ΔX, ΔY) of the palm according to the center point coordinates Aₛ (Xₛ, Yₛ, Zₛ) at the first time point and the center point coordinates Aₑ (Xₑ, Yₑ, Zₑ) at the second time point. The processor 104 correspondingly outputs a control signal 126 to the camera 102 according to the displacement value (ΔX, ΔY), so that the camera 102 turns in a direction according to the control signal 126. For example, the control signal 126 records the digital signal corresponding to the displacement value (ΔX, ΔY) information. When the camera 102 receives the control signal 126, the lens of the camera 102 can be turned left and right, or tilted up and down according to the displacement value (ΔX, ΔY), so that the camera 102 can continuously track the user's hand and keep the palm of the image 120 in the center of the screen of the display 106.

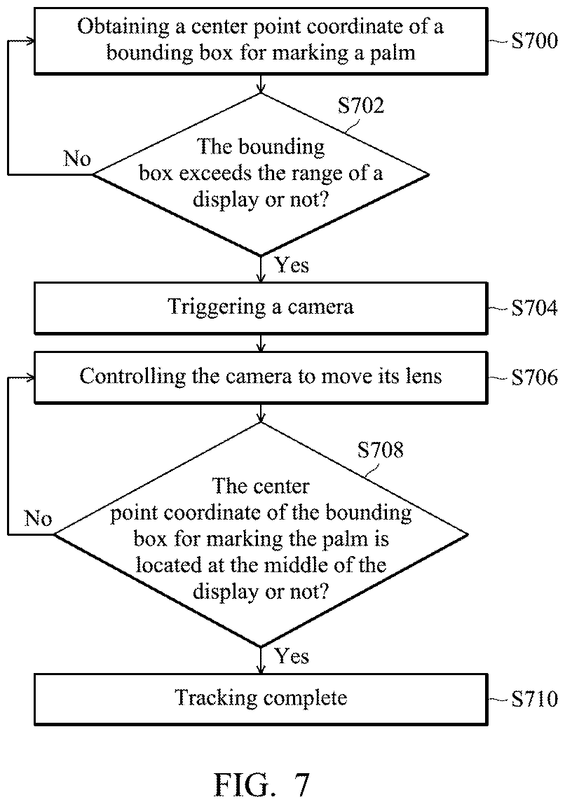

FIG. 7 is a flow chart of the processor 104 of the electronic device 100 controlling a camera 102 to track the hand in accordance with some embodiments of the disclosure. As shown in FIG. 7, the process of the processor 104 executing the hand motion detection algorithm 114 to control the camera 102 to track the hand includes steps S700˜S710. In step S700, the processor 104 obtains center point coordinates of a bounding box for marking a palm. In step S702, the processor 104 determines whether the bounding box used to mark the palm exceeds the image (for example, the image 120) captured by the lens of the camera 102. When the bounding box exceeds the screen of the display 106, the processor 104 outputs a control signal 126 to trigger the camera 102 in step S704. Then, in step S706, the processor 104 outputs the control signal 126 to control the camera 102 to turn its own lens.

In step S708, the processor 104 determines whether the center point coordinates of the bounding box for marking the palm is located in the middle (or center) of the screen of the display 106 or not. When the center point coordinates of the bounding box is in the middle the display 106, the processor 104 completes the hand tracking in step S710. In some embodiments, when the processor 104 determines in step S702 that the bounding box does not exceed the range of the display 106, or does not exceed the image captured by the lens of the camera 102, the processor 104 executes step S700 again. In some embodiments, when the processor 104 determines in step S708 that the center point coordinates of the bounding box for marking the palm is not located in the middle of the screen of the display 106, the processor 104 executes step S706 again until the center coordinates of the bounding box is in the middle of the screen.

The ordinals in the specification and the claims of the present invention, such as “first”, “second”, “third”, etc., have no sequential relationship, and are just for distinguishing between two different components with the same name. In the specification of the present invention, the word “couple” refers to any kind of direct or indirect electronic connection. The present invention is disclosed in the preferred embodiments as described above, however, the breadth and scope of the present invention should not be limited by any of the embodiments described above. Persons skilled in the art can make small changes and retouches without departing from the spirit and scope of the invention. The scope of the invention should be defined in accordance with the following claims and their equivalents.

What is claimed is:

1. An electronic device, comprising:
a camera, providing an image;
a display, displaying a cursor;
a processor, which executes:
a palm detection algorithm to identify a palm in the image and mark a bounding box around the palm;
a hand key-point detection algorithm to mark a plurality of key points on the palm that has been marked in the image to obtain spatial coordinates of the key points on the palm;
a hand motion detection algorithm to correspondingly control the camera to turn in a direction, to correspondingly move the cursor in the display according to the position change of the bounding box around the palm, and to trigger an event according to the change of spatial coordinates of at least one of the key points on the palm within a certain period of time.

2. The electronic device as claimed in claim 1, further comprising a database; wherein the database stores a plurality of images of the palm; wherein the processor inputs the images of the palm into the palm detection algorithm and the hand key-point detection algorithm for deep learning.

3. The electronic device as claimed in claim 1, wherein the processor executes the hand motion detection algorithm, so that the processor calculates center point coordinates corresponding to a center point of the bounding box according to the range of the bounding box.

4. The electronic device as claimed in claim 1, wherein the palm detection algorithm and the hand key-point detection algorithm are convolution neural network (CNN) algorithms; wherein the hand key-point detection algorithm is also a convolution pose machine (CPM) algorithm.

5. The electronic device as claimed in claim 3, wherein the processor executes the hand motion detection algorithm, comprising:
obtaining first center point coordinates of the bounding box at a first time point;
obtaining second center point coordinates of the bounding box at a second time point;
calculating a displacement value for the palm according to the first center point coordinates and the second center point coordinates;
converting the displacement value into a pixel coordinate displacement value in the display;
moving the cursor in the display according to the pixel coordinate displacement value.

6. The electronic device as claimed in claim 3, wherein the processor executes the hand motion detection algorithm comprising:
obtaining first center point coordinates of the bounding box at a first time point;
obtaining second center point coordinates of the bounding box at a second time point;
calculating a displacement value of the palm according to the first center point coordinates and the second center point coordinates;
correspondingly outputting a control signal to the camera according to the displacement value, so that the camera turns in a direction according to the control signal.

7. The electronic device as claimed in claim 1, wherein the processor executes the hand motion detection algorithm, comprising:
obtaining first spatial coordinates of at least one of the key points at a first time point;
obtaining second spatial coordinates of at least one of the key points at a second
calculating a vertical displacement value of at least one of the key points on the palm according to the first spatial coordinates and the second spatial coordinates;
calculating a displacement speed of at least one of the key points on the palm according to a time difference between the first time point and the second time point and the vertical displacement value.

8. The electronic device as claimed in claim 1, wherein at least one of the key points on the palm is the key point at the extreme end of an index finger or a middle finger of the hand.

9. The electronic device as claimed in claim 8, wherein the processor triggers the event comprising:
executing an action performed when a left or a right button of a mouse is clicked.

10. The electronic device as claimed in claim 1, wherein the camera is a pan-tilt-zoom (PTZ) camera.
